(19) United States
(12) Patent Application Publication
(10) Pub. No.: US 2004/0054754 A1
(43) Pub. Date: Mar. 18, 2004

(54) System and method for automatic internet access

(76) Inventors: Ki Soo Hwang, Seoul (KR); Jun Kyu Song, Gyeonggi-do (KR); Young Soo Hong, Gyeonggi (KR); Suk Joong Lee, Seoul (KR); Byong Su Kim, Gyeonggi (KR); In Kyeom Kim, Kyeonggi (KR); Sang Don Park, Seoul (KR)

Correspondence Address: CANTOR COLBURN, LLP, 55 GRIFFIN ROAD SOUTH, BLOOMFIELD, CT, 06002

(21) Appl. No.: 10/416,811

(22) PCT Filed: Aug. 29, 2001
(86) PCT No.: PCT/KR01/01455

(30) Foreign Application Priority Data
Nov. 7, 2000 (KR) 2000/65994

(51) Int. Cl. G06F 15/16

(52) U.S. Cl. 709/217

(57) ABSTRACT

The present invention relates to a system and method for automatically accessing a corresponding Internet web page by inputting a code recorded on a printed medium without inputting a uniform resource locator (URL) or performing hyperlink operation in a web browser. In an automatic Internet access system according to the present invention, instead of simply forming an Internet access node using the URL of a web page to be accessed, the Internet access code is formed using index information, double code information containing a server code and an index code, or hierarchical code information containing a service code and a detailed code. The automatic Internet access system includes a code input device for deciphering code information from a code which is recorded in an offline medium and related to the web page, a user computer for decoding the code information deciphered by the code input device and implementing Internet access, an address server for providing URL information of the web page using the code information transmitted form the user computer, and a routing server for deciphering the code information transmitted form the user computer and transmitting a dtailed code to corresponding service providing server.

### TECHNICAL FIELD

The present invention relates to a system and method for automatic Internet access and more particularly, to a system and method for automatically accessing a corresponding Internet web page by inputting a code recorded on a printed medium without inputting a uniform resource locator (URL) or performing hyperlink operation in a web browser.

In order to use information on Internet through a user's computer, the computer must be connected to the Internet by subscribing for a PC communication service or securing a private line, and an Internet access program and an Internet search program, i.e., a web browser, such as Internet Explorer or Netscape, must be installed in the computer. In searching information at a predetermined location in a particular web site on the Internet, a user usually turns on the user's computer, executes an Internet access program, executes a web browser, inputs the address of the particular web site, and searches data of a particular web page or file. In some occasions, it is not necessary to execute a special Internet access program, or an Internet access, program and an Internet search program may be integrated into a single program. However, such an Internet information search procedure is too complicated for persons who are not familiar with the Internet. Moreover, it takes much time until a user obtains information on a particular web page after executing a web browser during an Internet information search procedure, so even the user familiar with the Internet is often bored with the search procedure.

### BACKGROUND ART

It is a personal computer that is most universally used for access to Internet. In order to access the Internet under a personal computer environment, a web browser such as Internet Explorer or Netscape must be installed in a personal computer. In the case where a personal computer is connected to a LAN connected to a private line, a user can immediately search Internet information by executing a web browser because Internet access is accomplished when the personal computer is turned on. However, in the case where a personal computer is connected to a normal telephone line, a user must log in ar Internet service provider (ISP) through PC communication using an Internet access program before executing a web browser to search Internet information. Conversation between a web browser and a web server is defined by a HyperText Transfer Protocol (HTTP). A web browser sends a message according to the HTTP to a web server, and the web server sends requested information to the web browser. It is apparent that a protocol, such as a File Transfer Protocol (FTP), other than the HTTP and an FTP program instead of a web browser may be used for Internet search. In this specification, all Internet search programs such as a web browser and an FTP program are simply referred to as a web browser.

Each of all the web pages on the Internet has an address referred to as a uniform resource locator (URL). When creating an HTML web page, the URL of other web page can be linked to a character stream or a picture on the created HTML web page for user to shift to the other web page. This is referred to as a hyperlink. The URL is an address indicating the name of a server having information, the directory path of a file, and the name of the file. The URL usually has a form of “Internet Protocol (IP) address/path/file name”. For example, the URL of a particular web page in a sub-directory about “arts and culture” among web sites of the “Yahoo Korea” may be www.yahoo.co.kr/Arts/20000323.html. The URL of a particular web page in a directory referred to as “photograph” below the sub-directory about ““arts and culture” among the web sites of the “Yahoo Korea” may be www.yahoo.co.kr/Arts/Visual_Arts/Photography/dataname.html. In the above URLs, “www.yahoo.co.kr” in the beginning portion indicates an IP address, “Arts” or “Arts/Visual_Arts/Photography” in the middle portion indicates a path, and “20000323.html” or “dataname.html” in the last portion indicates a file name of the particular web page. Originally, an IP address indicates the address of each computer composed of numerals, for example, 210.11.204.253. However, an address composed of numerals is difficult to remember and inconvenient in use, so users usually use a domain name, for example, www.yahoo.co.kr, which is composed of characters and corresponds to the IP address. When a domain name is used, a user is actually connected to an IP address. In this specification, an IP address may include a domain name. In addition, in some occasions, a URL can be expressed in a form such as http://www.yahoo.co.kr/Arts/20000323.html. Here, “http://” indicates a protocol. In this specification, a URL may include information about a protocol.

A URL specifies how individual resources or objects, such as files, documents, or particular portions of a document, are discriminated within a world wide web (WWW). A web browser specifies exactly what resource is requested from a web server using such a URL. In this specification, terms such as a web page and a file for individual resources are used together.

Even a user who is not familiar with the Internet can easily access a homepage registered during initial setting by clicking the icon of a web browser such as Explorer or Netscape displayed on a desktop of a personal computer using a mouse. Thereafter, the user can search for a place corresponding to a desired URL in a hierarchical structure of a homepage by directly inputting the URL on the web browser or clicking a mouse on a higher class of the homepage. However, this method is very inconvenient when the hierarchical structure of the homepage is complicated or when a domain name is very long.

To solve the problem of inconvenience of searching in a complicated hierarchical structure of a homepage when a user accesses the Internet, recently, an automatic Internet access tool for reading a code (hereinafter, referred to as an “Internet access code”) related to the URL of a particular web page on the Internet and immediately accessing the web page has been introduced. Particularly, U.S. Pat. No. 5,933,829 issued to NeoMedia Technologies Inc. discloses a system and method for automatically accessing electronic information using a machine-readable code printed on a document. U.S. Pat. No. 5,933,829 issued to NeoMedia Technologies Inc. proposes a system and method for converting the uniform product code of a product into an IP address or a URL to access an Internet resource of the product.

An Internet access code proposed in U.S. Pat. No. 5,933,829 issued to NeoMedia Technologies Inc. includes URL information of a web page which a user wants to access. However, some URLs on a web page cannot be expressed by an Internet access code.

For example, a company named Naver on the Internet manages a site for searching web sites and provides real-time stock quotes as an additional service. The URL of a homepage on which Naver provides stock information is http://stock.naver.com. When the stock quote of Hyundai Electronics is inquired on this site, an inquired URL is http://stock.naver.com/naverstock?command=profile&code=00660. The length of this URL is 60 characters. When each character is expressed by an ASCII code, 8*60=480 bits are used. Accordingly, such a URL cannot be expressed by a one-dimensional binary bar code. A two-dimensional bar code can express more amount of information per unit area than a one-dimensional bar code, so the above URL can be expressed by the two-dimensional bar code. However, a URL longer than the above URL cannot be expressed even by the two-dimensional bard code. Accordingly, a direct access method of directly including a URL in an Internet access code has limitations.

### DISCLOSURE OF THE INVENTION

To overcome the above problems, it is a first object of the present invention to provide an automatic Internet access system and method using an indirect code for easily accessing a web page having a long uniform resource locator (URL) by recording an index of the URL in an Internet access code instead of directly recording the URL and for integrally managing information about web page access.

It is a second object of the present invention to provide an automatic Internet access system and method using a double code for equalizing loads on an address server, which accompany automatic Internet access, by forming an Internet access code as a double code including a server code and an index code and supporting a plurality of address servers.

It is a third object of the present invention to provide an automatic Internet access system and method using a hierarchical code for efficiently providing various services by forming an Internet access code as a hierarchical code including a service code and a detailed code.

To achieve the first object of the invention, there is provided an automatic Internet access method of accessing a particular web page on Internet. The automatic Internet access method includes the steps of (a) deciphering code information from a code which is recorded in an offline medium and is related to the web page; (b) decoding the deciphered code information to acquire index information related to the web page; (c) acquiring address information corresponding to the acquired index information on a network; and (d) accessing the web page using the acquired address information and receiving information related to the web page.

To achieve the first object of the invention, in one embodiment, there is provided an automatic Internet access system for accessing a particular web page on Internet. The automatic Internet access system includes a code input device for deciphering code information from a code which is recorded in an offline medium and is related to the web page; an address server for receiving index information and providing address information corresponding to the index information on a network; and a user computer for decoding the code information deciphered by the code input device to acquire the index information related to the web page, acquiring the address information corresponding to the index information using the address server, accessing the web page using the address information, and receiving information related to the web page.

To achieve the first object of the invention, in another embodiment, there is provided an automatic Internet access system for accessing a particular web page on Internet. The automatic Internet access system includes a code input device for deciphering code information from a code which is recorded in an offline medium and is related to the web page and decoding the deciphered code information to acquire index information related to the web page; an address server for receiving index information and providing address information corresponding to the index information on a network; and a user computer for acquiring the address information, which corresponds to the index information acquired by the code input device, using the address server, accessing the web page using the address information, and receiving information related to the web page.

To achieve the second object of the invention, there is provided an automatic Internet access method of accessing a particular web page on Internet. The automatic Internet access method includes the steps of (a) deciphering code information from a code which is recorded in an offline medium and is related to the web page; (b) decoding the deciphered code information to acquire double code information related to the web page; (c) transmitting an index code contained in the double code information to an address server corresponding to a server code contained in the double code information; (d) receiving address information corresponding to the index code from the address server; and (e) accessing the web page using the address information and receiving information related to the web page.

To achieve the second object of the invention, there is also provided an automatic Internet access system for accessing a particular web page on Internet. The automatic Internet access system includes a user computer for deciphering code information from a code which is recorded in an offline medium and is related to the web page, decoding the deciphered code information to acquire double code information related to the web page, and transmitting an index code contained in the double code information to an address server corresponding to a server code contained in the double code information; and a plurality of address server for receiving the index code, acquiring address information corresponding to the index code, and transmitting the address information to the user computer. The user computer accesses the web page using the address information and receives information related to the web page.

To achieve the third object of the invention, there is also provided an automatic Internet access method of accessing a particular web page on Internet. The automatic Internet access method includes the steps of (a) deciphering code information from a code, which is recorded in an offline medium and is related to the web page, using a user computer; (b) decoding the deciphered code information to acquire hierarchical code information related to the web page using the user computer; (c) transmitting the hierarchical code information from the user computer to a routing server; (d) transmitting a detailed code contained in the hierarchical code information from the routing server to a service providing server corresponding to a service code contained in the hierarchical code information among a plurality of service providing servers; and (e) transmitting resulting information corresponding to the detailed code from the service providing server to the user computer.

To achieve the third object of the invention, there is also provided an automatic Internet access system for accessing a particular web page on Internet. The automatic Internet access system includes a user computer for deciphering code information from a code which is recorded in an offline medium and is related to the web page, decoding the deciphered code information to acquire hierarchical code information related to the web page, and transmitting the hierarchical code information to a routing server; a routing server for transmitting a detailed code contained in the hierarchical code information to a service providing server corresponding to a service code contained in the hierarchical code information among a plurality of service providing servers; and a plurality of service providing servers for transmitting resulting information corresponding to the detailed code to the user computer.

### BRIEF DESCRIPTION OF THE DRAWINGS

FIG. 1 is a block diagram of an automatic Internet access system using an indirect code according to a first embodiment of the present invention.

FIG. 2 is a flowchart of an automatic Internet access procedure using an indirect code according to the first embodiment of the present invention.

FIGS. 3A and 3B are exemplary diagrams of a one-dimensional bar code and a two-dimensional bar code, respectively.

FIG. 4 is an exemplary diagram of a state of deciphering or capturing image information of an Internet access code inscribed near news on a paper using a code input device.

FIG. 5 is an exemplary diagram of the configuration of index information according to the first embodiment of the present invention.

FIG. 6 is an exemplary diagram of a data structure in a memory unit included in an address server according to the first embodiment of the present invention.

FIG. 7 is a block diagram of an automatic Internet access system using a double code according to a second embodiment of the present invention.

FIG. 8 is a flowchart of an automatic Internet access procedure using a double code according to the second embodiment of the present invention.

FIG. 9A is a diagram of the structure of a double code according to the second embodiment of the present invention, and FIG. 9B is an exemplary diagram of a double code expressed by a two-dimensional bar code and a one-dimensional bar code.

FIG. 10 is a conceptual diagram of a memory unit included in an address server having a domain name, stock.naver.com.

FIG. 11 is a diagram of an automatic Internet access system using a hierarchical code according to a third embodiment of the present invention.

FIG. 12 is a flowchart of an automatic Internet access procedure using a hierarchical code according to the third embodiment of the present invention.

FIG. 13A is an exemplary diagram of a hierarchical code expressed by a one-dimensional code, and FIG. 13B is a detailed diagram of a data structure in a hierarchical code.

FIG. 14 is an exemplary diagram showing the kinds of service code in a hierarchical code used in the third embodiment of the present invention.

FIG. 15 is an exemplary diagram of the configuration of a code input device used in the present invention.

### BEST MODE FOR CARRYING OUT THE INVENTION

Hereinafter, embodiments of the present invention will be described in detail with reference to the attached drawings.

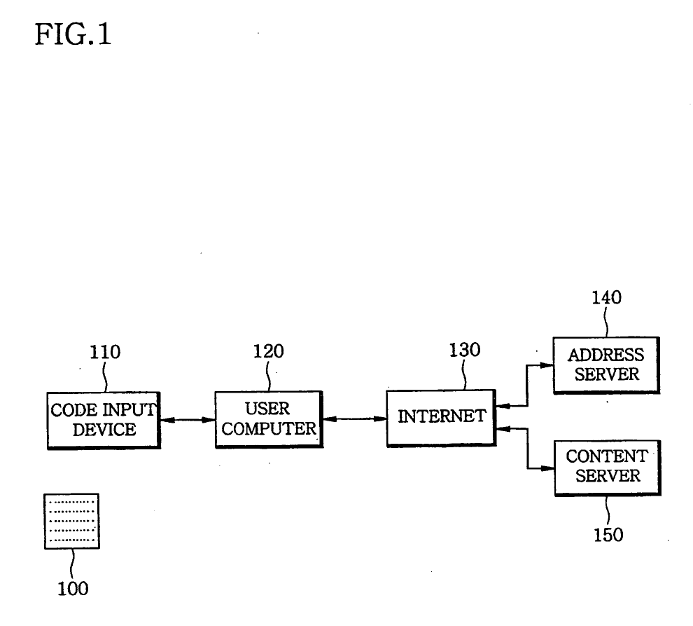

FIG. 1 is a block diagram of an automatic Internet access system using an indirect code according to a first embodiment of the present invention. Referring to FIG. 1, the automatic Internet access system according to the first embodiment of the present invention includes a code input device 110, an address server 140, and a user computer 120.

The code input device 110 deciphers code information from a code 100 which is written on an offline medium such as a newspaper, magazine, or an advertising bill and which is related to a web page. Accordingly, the code input unit device 110 includes a reading unit such as a digital camera or a scanner for reading the one-dimensional or two-dimensional code 100 related to the URL of a web page to be accessed and a transmitting unit for transmitting the deciphered digital code information to the user computer 120.

The user computer 120 performs automatic Internet access using the code information transmitted from the code input device 110. The user computer 120 may be a fixed computer or a portable terminal. A fixed computer used as the user computer in this embodiment may be a personal computer, a notebook computer, a workstation, a web TV, a click TV, or a video game station. A portable terminal used as the user computer in this embodiment may be a mobile telephone, a PDA, or a portable game station. Regardless of a fixed computer or a portable terminal, it is supposed that the user computer 120 used in this embodiment of the present invention allows access to the Internet through subscription for a PC communication service or securing of a private line, allows Internet search through a web browser such as Internet Explorer or Netscape, and allows execution of an application program for decoding the code information input from the code input device 110. The user computer 120 accesses the address server 140 and a content server 150 through the Internet 130. The user computer 120 transmits web page-related index information acquired by decoding the code information received from the code input device 110 to the address server 140 and requests address information corresponding to the index information.

The address server 140 receives the index information from the user computer 120 obtains corresponding address information on a network, and provides the address information to the user computer 120.

Meanwhile, the content server 150 indicates a portal site or web site of an organization or an association, which includes a web page that the user computer 120 is to access using the address information received from the address server 140. For example, Dong-a ilbo's web site (www.dongailbo.co.kr), Auction's site (www.auction.co.kr), or Seoul National University's web site (www.snu.ac.kr) can function as the content server 150.

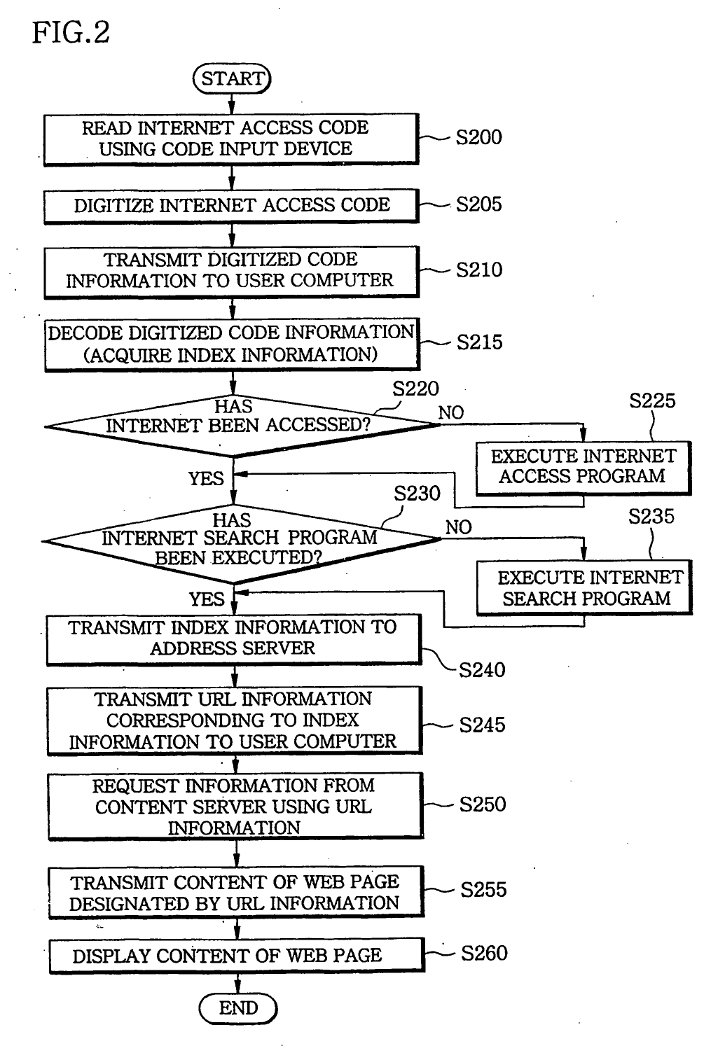

FIG. 2 is a flowchart of an automatic Internet access method of searching a particular web page on the Internet using an automatic Internet access system using an indirect code according to the first embodiment of the present invention.

The code input device 110 reads the code 100, which is marked on a newspaper or other advertising medium and indicates information related to the URL of a particular web page, in response to a user's operation in step S200. Hereinafter, the code 100 is referred to as an Internet access code 100.

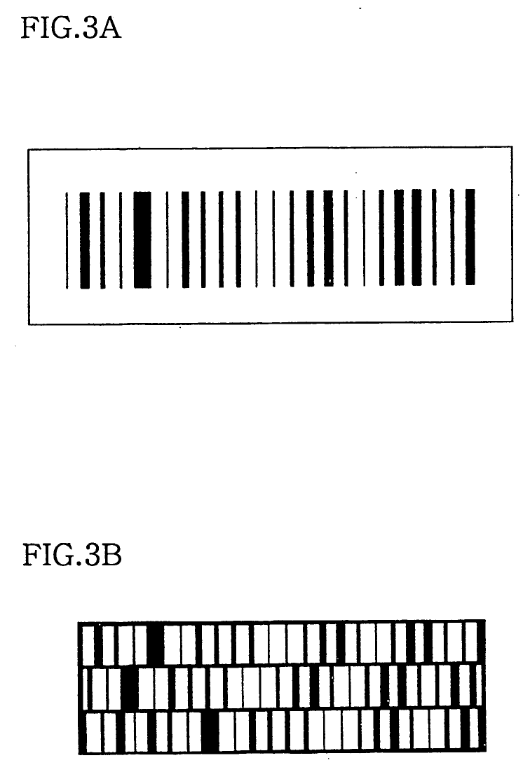

FIGS. 3A and 3B show the examples of the Internet access code 100. The Internet access code 100 used in the present invention may be a one-dimensional type, as shown in FIG. 3A, or a two-dimensional type, as shown in FIG. 3B. The Internet access code 100 may comply with a creative system, which is uniquely designed for an automatic Internet access system according to the present invention, or a universal code system widely used. Regardless of the type of code system, index information corresponding to the URL of a particular web page is ciphered in the Internet access code 100.

At present, most newspaper publishing companies manage their homepages on the Internet. Accordingly, persons can read news on a newspaper provided in offline or can read news on a web site through Internet access. When a newspaper publishing company additionally provides information or moving images related to a particular news item through the Internet, the Internet access code of a particular web page or file storing information related to the news item can be written on a newspaper near the news item. While reading a newspaper, a reader can see the Internet access code 100 in the content of the new item. When the reader wants to see more detailed content or moving images related to the news item, the Internet access code 100 can be read using the code input device 110.

For example, a picture taken from a helicopter showing that citizens participating in 71st Dong-a International Marathon are running in groups and a related new item were published in the front page of Dong-a ilbo dated Mar. 20th in 2000. In this case, the Internet access code 100 of Dong-a ilbo's web page providing a scene, in which a winner reaches the finish line, in the form of moving images can be provided near the content about male and female winners and other stories about the race. Moving images showing male and female winners reach the finish line in the Dong-a International Marathon can be provided on a particular web page of the Dong-a ilbo's web site (for example, a web page designated by a URL, www.dongailbo.co.kr/sports/6589.html). It will be apparent that the above IP address, path and file name are only examples, and any type of URL can be used. When a reader wants to see such moving images, the Internet access code 100 provided near the content of news is read using the code input device 110. The Internet access code 100 contains ciphered index information corresponding to the URL of a file related to the above-described moving images.

Here, the user computer 120 is in a power-off state, it is necessary to automatically or manually boot the user computer 120.

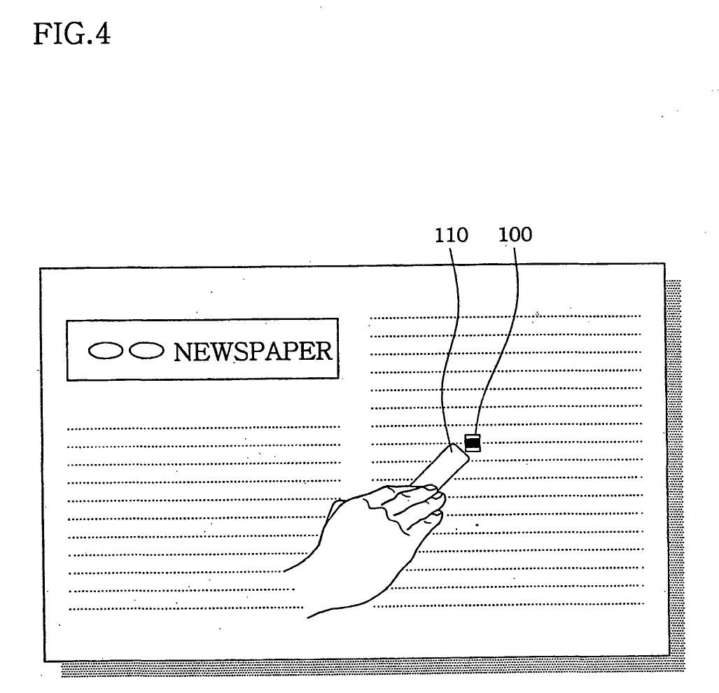

FIG. 4 shows an example of a state of deciphering or capturing image information of the Internet access code 100 inscribed near the content of news on a newspaper using the code input device 110.

Referring again FIGS. 1 and 2, the Internet access code 100 is digitized by a central processing unit provided in the code input device 110 in step S205. Digitized code information is transmitted to the user computer 120 in step S210. Here, the Internet access code 100 read by the code input device 110 is transmitted to the user computer 120 in the form of digitized code image information. Alternatively, the Internet access code 100 read by the code input device 110 can be decoded by the code input device 110, and decoded index information can be transmitted to the user computer 120.

The user computer 120 decodes the digitized code image information to acquire index information corresponding to the address of a particular Internet web page in step S215. The index information contains information related to the URL of the particular web page but has not a form which can be used as the URL of the web page to be searched through a web browser.

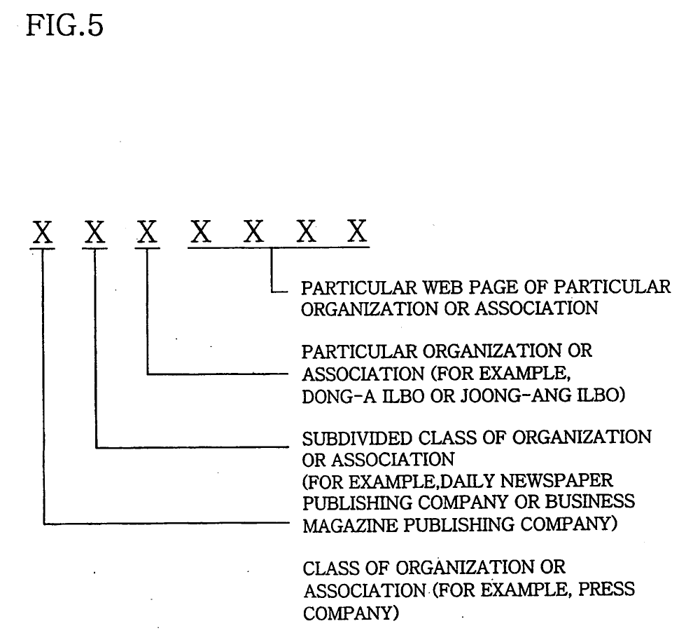

FIG. 5 is an exemplary diagram of the configuration of index information according to the first embodiment of the present invention. In the first embodiment of the present invention, the index information has a form of a seven-digit Arabic number. The first three digits of the seven-digit Arabic number are used for indicating an organization or an association, which manages its homepage. The first digit of the index information indicates the class of an organization or association, such as a school, a hospital, a government agency, a press company, or a general company. The second digit indicates a subdivided class of an organization or association. The third digit indicates a particular organization or association belonging to the class. The last four digits of the seven-digit Arabic number indicates the address of a web page containing particular content in a homepage managed by the particular organization or association. For example, when the index information is “2346589”, “2” in the first digit indicates a press company. “3” in the second digit indicates a general daily newspaper publishing company among press companies. “4” in the third digit indicates Dong-a ilbo among general daily newspaper publishing company. “6” in the fourth digit indicates a class of sports among web pages of Dong-a ilbo, and “589” in the rest digits indicates a particular web page. The length of an index determines the number of indicatable organizations or associations and the number of web pages which a particular organization or association can have. The index information composed of a seven-digit Arabic number is just an example. It will be apparent that the index information can have any other form including alphabet or other symbols.

Subsequently, it is determined whether the user computer 120 has accessed the Internet 130 in step S220. If it is determined that the user computer 120 has not accessed the Internet 130, an internet access program previously installed in the user computer 120 is executed for access to the Internet 130 in step S225. These steps can be performed manually but can be automatically performed by a predetermined program installed in the user computer 120. If it is determined that the user computer 120 has accessed the Internet 130 in step S220, or after completing access to the Internet 130 through step S225, it is determined whether an Internet search program has been executed in the user computer 120 in step S230. If it is determined that an Internet search program has not been executed, an Internet search program set in the user computer 120 is executed in step S235. For the Internet access program and the Internet search program, existing programs can be used in this embodiment of the present invention. However, it will be apparent that predetermined programs created according to the present invention can be used.

Thereafter, the user computer 120 transmits an address information request message to the address server 140 through the Internet 130 using the Internet search program in step S240. The address information request message contains the index information acquired by the user computer 120.

The address server 140 includes a memory unit (not shown) which stores indexes and URL information corresponding to the indexes. Accordingly, the address server 140 receiving the index information from the user computer 120 searches its memory unit and transmits URL information corresponding to the index information to the user computer 120 in step S245.

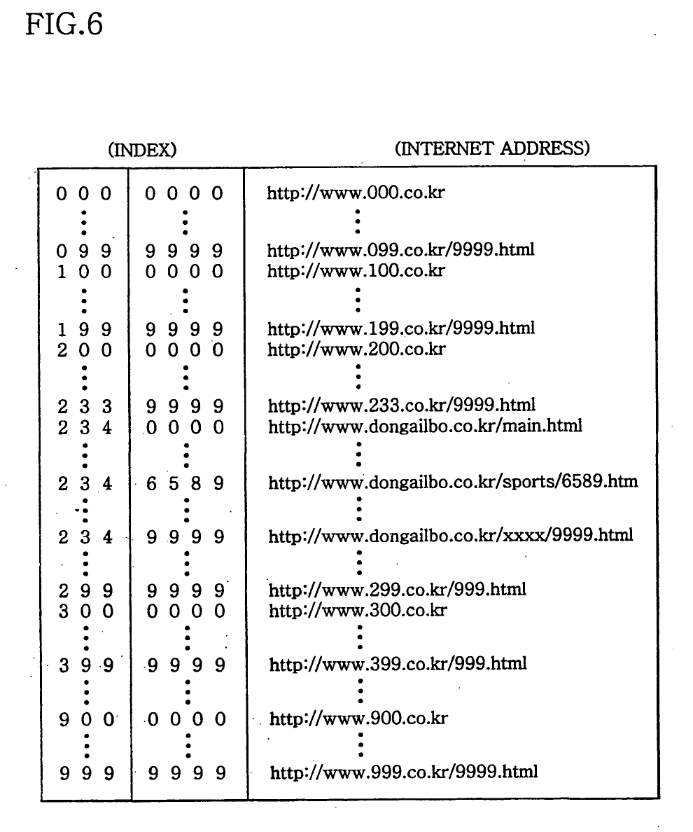

FIG. 6 is an exemplary diagram of a data structure in a memory unit provided in the address server 140 according to the present invention. 1000 content providers (organizations or associations) can be discriminatively designated using the first three-digits (000˜999) of individual indexes. 10,000 web pages provided by content providers can be discriminatively designated using the rest four-digits of the individual indexes.

The memory unit of the address server 140 has memory numbers which correspond to index information transmitted from the user computer 120 one to one and stores address information, for example, URL information, of a predetermined particular web page on the Internet at a location designated by each memory number. In some occasions, protocol information such as HTTP can be contained in URL information. For example, when index information transmitted from the user computer 120 is “2346589”, “234” indicates the homepage of Dong-a ilbo, “6” indicates the class of sports, and “589” indicates the address of a web page containing a moving image file of male and female winners of Dong-a Marathon, so it can be inferred that address information corresponding to the index information on the Internet is www.dongailbo.co.kr/sports/6589.html.

As described above, if the user computer 120 transmits index information (for example, 2346589) to the address server 140, the address server 140 performs internal search, derives URL information (for example, www.dongailbo.co.kr/sports/6589.html) stored at a location designated by the index information, and transmits the derived URL information to the user computer 120.

The Internet search program executed in the user computer 120 accesses the content server 150 through the Internet 130 using the URL information transmitted from the address server 140 and requests desired information in step S250. Then, the content server 150 transmits the content of a web page designated by the URL information transmitted from the user computer 120 to the user computer 120 in step S255. Thereafter, the user computer 120 displays the content of the web page transmitted from the content server 150 on its display unit in step S260. With such a method, a user can obtain additional information related to the Internet access code 100 inscribed on a newspaper.

As described above, according to an automatic Internet access system and method using an indirect code (hereinafter, referred to as a “indirect access method”) according to the present invention, even a web page, whose URL is too long to be accessed by a direct access method, can be easily accessed, and information about users' access to a particular web page can be integrally managed in the address server 140.

However, according to the indirect access method, only one address server searches address information corresponding to index information transmitted from a plurality of user computers and transmits search results to the individual user computers. Accordingly, when there are many users, the load on the address server increases, which may results in a bottleneck phenomenon.

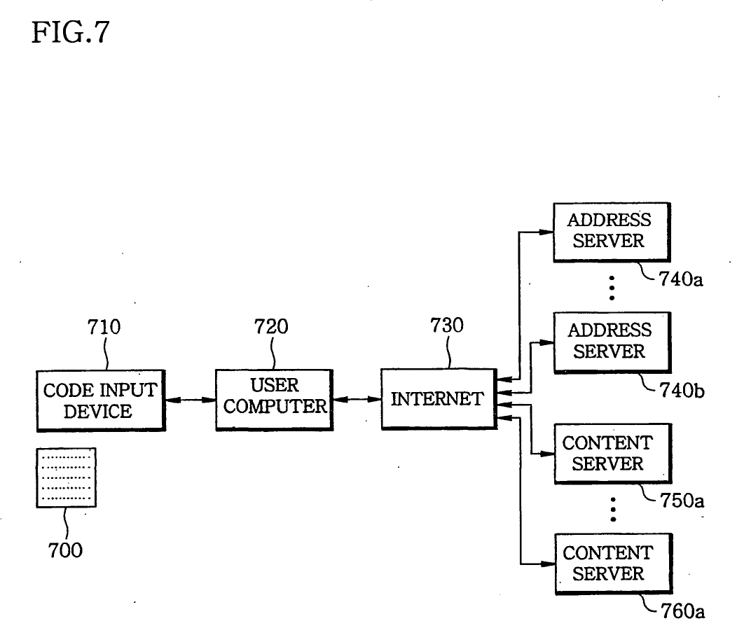

FIG. 7 is a block diagram of an automatic Internet access system using a double code according to a second embodiment of the present invention. Referring to FIG. 7, the automatic Internet access system according to the second embodiment of the present invention includes a code input device 710, address servers 740a and 740b, and a user computer 720.

The code input device 710 deciphers code information from a code 700 which is written on an offline medium such as a newspaper, magazine, or an advertising bill and which is related to a web page. Accordingly, the code input unit device 710 includes a reading unit such as a digital camera or a scanner for reading the one-dimensional or two-dimensional code 700 related to the URL of a web page to be accessed and a transmitting unit for transmitting the deciphered digital code information to the user computer 720.

The user computer 720 performs automatic Internet access using the code information transmitted from the code input device 710. The user computer 720 may be a fixed computer or a portable terminal. Regardless of a fixed computer or a portable terminal, it is supposed that the user computer 720 used in this embodiment of the present invention allows access to the Internet through subscription for a PC communication service or securing of a private line, allows Internet search through a web browser such as Internet Explorer or Netscape, and allows execution of an application program for decoding the code information input from the code input device 710. The user computer 720 accesses the plurality of address servers 740a and 740b and a plurality of content servers 750a and 750b through the Internet 730. The user computer 720 acquires double code information by decoding the code information received from the code input device 710, transmits an index code contained in the double code information to the address server 740a or 740b corresponding to a server code contained in the double code information, and requests address information corresponding to the index code.

Each of the address servers 740a and 740b receives the index code from the user computer 720, obtains corresponding address information on a network, and provides the address information to the user computer 720.

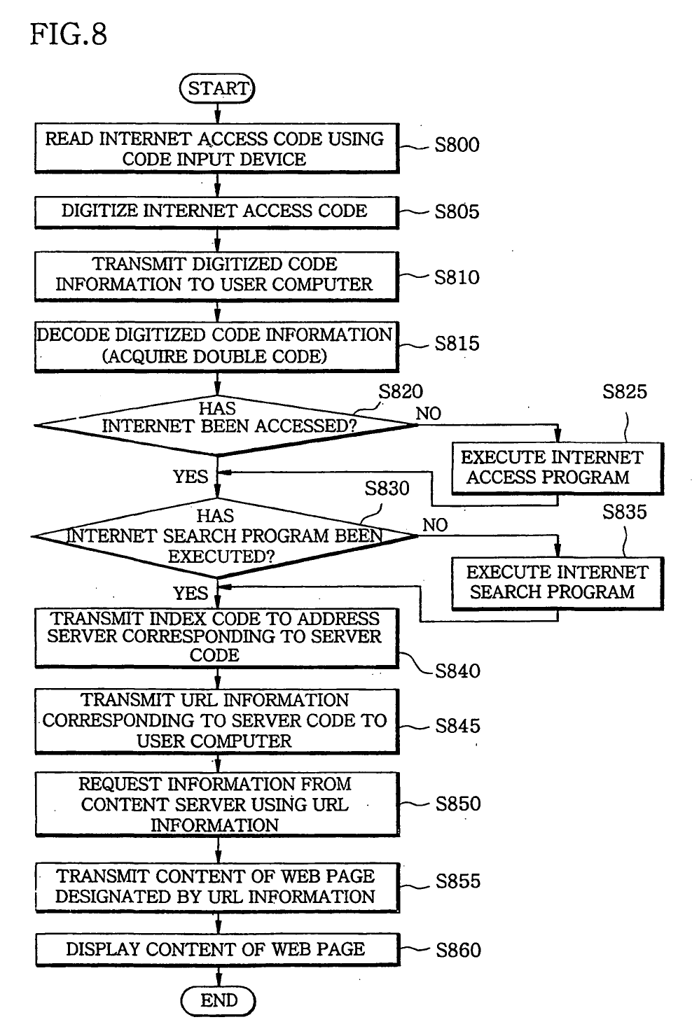

FIG. 8 is a flowchart of an automatic Internet access method of searching a particular web page on the Internet using an automatic Internet access system using a double code according to the second embodiment of the present invention.

The code input device 710 reads the Internet access code 700, which is marked on a newspaper or other advertising medium and indicates information related to the URL of a particular web page, in response to a user's operation in step S800.

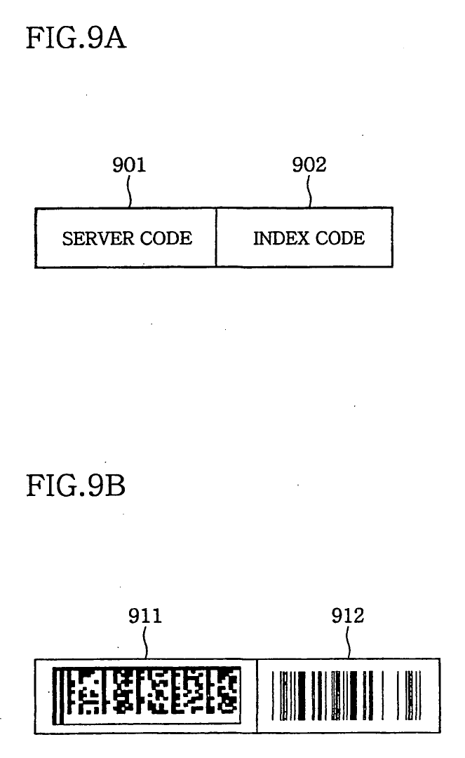

As shown in FIG. 9A, a double code according to the second embodiment of the present invention includes a server code 901 and an index code 902. Such double code can be represented by a one-dimensional bar code shown in FIG. 3A. In the case of one-dimensional bar code, a code itself is standardized to some extent, and significant data can be expressed in a small area. However, when recording a value (for example, an English letter or Korean letter) other than a binary value, the amount of data which can be recorded in a unit area decreases. Accordingly, a one-dimensional bar code is incompetent as an Internet access code for recording data other than a binary value.

When a one-dimensional bar code is read to decipher a code value, a one-dimensional value is read, that is, only one line is read in a progressing direction of the code. Unlike such one-dimensional bar code, both x-axis data and y-axis data of a code are necessary when a two-dimensional bar code shown in FIG. 3B is read. Accordingly, in order to decipher a two-dimensional bar code, the two-dimensional image of the entire code must be read. Unlike a one-dimensional bar code, since a two-dimensional bar code can express Korean letters and special characters as well as English letters, it is not limited to a certain type of data to be recorded. However, compared to a one-dimensional bar code, a two-dimensional bar code decreases the amount of data which can be recorded in a unit area.

In order to represent a double code according to the second embodiment of the present invention, an efficient Internet access code can be composed using two different types of codes having different characteristics. In other words, it is preferable that a two-dimensional bar code is used for representing a server code 901 of a double code, and a one-dimensional bar code is used for representing an index code 902 of the double code. Here, the two-dimensional bar code directly indicates the address of an address server, and the one-dimensional bar code indicates index information for deriving a value corresponding to a portion of the URL of a web page to be accessed except a portion corresponding to the address of the address server. FIG. 9B shows an example of an Internet access code composed of a two-dimensional code and a one-dimensional code. In other words, in FIG. 9B, reference numeral 911 denotes a server code represented by a two-dimensional code, and reference numeral 912 denotes an index code represented by a one-dimensional code.

Referring again FIGS. 7 and 8, the Internet access code 700 is digitized by a central processing unit provided in the code input device 710 in step S805. Digitized code information is transmitted to the user computer 720 in step S810. Here, the Internet access code 700 read by the code input device 710 is transmitted to the user computer 720 in the form of digitized code image information. Alternatively, the Internet access code 700 read by the code input device 710 can be decoded by the code input device 710, and decoded index information can be transmitted to the user computer 720.

The user computer 720 decodes the digitized code image information to acquire double code information including a server code and an index code in step S815.

Subsequently, it is determined whether the user computer 720 has accessed the Internet 730 in step S820. If it is determined that the user computer 720 has not accessed the Internet 730, an internet access program previously installed in the user computer 720 is executed for access to the Internet 730 in step S825. These steps can be performed manually but can be automatically performed by a predetermined program installed in the user computer 720. If it is determined that the user computer 720 has accessed the Internet 730 in step S820, or after completing access to the Internet 730 through step S825, it is determined whether an Internet search program has been executed in the user computer 720 in step S830. If it is determined that an Internet search program has not been executed, an Internet search program set in the user computer 720 is executed in step S835. For the Internet access program and the Internet search program, existing programs can be used in this embodiment of the present invention. However, it will be apparent that predetermined programs created according to the present invention can be used.

Thereafter, the user computer 720 transmits an address information request message to the address server 740a or 740b, which is designated by the server code 901 of the double code, through the Internet 730 using the Internet search program in step S840. The address information request message contains the index code 902 of the double code.

Each of the address servers 740a and 740b includes a memory unit (not shown) which stores indexes and URL information corresponding to the indexes. Accordingly, the address server 740a or 740b receiving an index code from the user computer 720 searches its memory unit and transmits URL information corresponding to the index code to the user computer 720 in step S845.

Steps S800 through S845 will be described using an example in which the URL of a web page to be accessed by the user computer 720 is http://stock.naver.com/naverstock?command=profile&code=00660.

In the Internet access code 700 read by the code input device 710, only a protocol portion, http://, and a domain portion, stock.naver.com, or only a domain portion is represented by a two-dimensional bar code, and the remaining portion, naverstock?command=profile&code=00660, is implemented an index information according to an indirect access method.

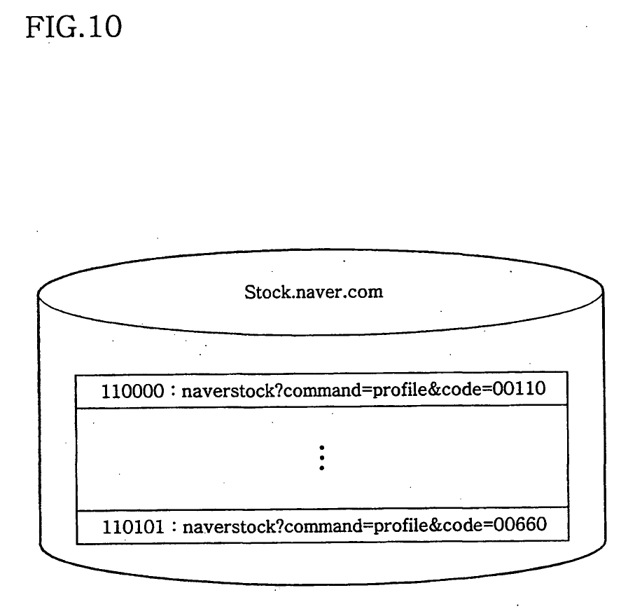

Accordingly, when the code input device 710 reads the Internet access code 700, the user computer 720 acquires a domain name (character information, “stock.naver.com”) from the two-dimensional bar code and index information (binary information, “110101”) from the one-dimensional bar code. The user computer 720 transmits the index information “110101” to a web site (or an address server) having the domain name “stock.naver.com”. The address server having the domain name “stock.naver.com” derives a URL value, naverstock?command=profile&code=00660, corresponding to the received index information “110101” from its memory unit. FIG. 10 is a conceptual diagram of a memory unit which is provided in an address server having a domain name, stock.naver.com, and stores indexes and corresponding URL values. The address server having the domain name, stock.naver.com, derives a URL value corresponding to an index “110101” from its memory unit and transmits the URL value to the user computer 720. Here, the address server may transmit a combination of the derived URL value and its domain name to the user computer 720.

Referring again FIGS. 7 and 8, the Internet search program executed in the user computer 720 accesses the content server 750a or 750b through the Internet 730 using URL information transmitted from the address server 740a or 740b and requests desired information in step S850. Then, the content server 750a or 750b transmits the content of a web page designated by the URL information transmitted from the user computer 720 to the user computer 720 in step S855. Thereafter, the user computer 720 displays the content of the web page transmitted from the content server 750a or 750b on its display unit in step S860. With such a method, a user can obtain additional information related to the Internet access code 100 inscribed on a printed medium.

According to such an automatic Internet access system using a double code as described above, a load attending upon the generation of a URL for automatic Internet access can be uniformly dispersed to a plurality of address servers.

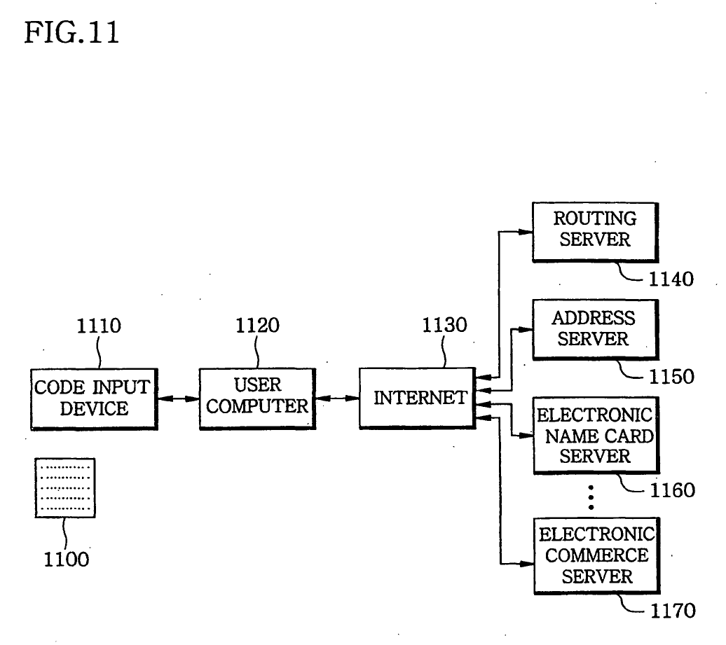

Meanwhile, in order to provide various services in addition to automatic Internet access, an automatic Internet access system according to a third embodiment of the present invention is provided below. FIG. 11 is a diagram of an automatic Internet access system using a hierarchical code according to the third embodiment of the present invention. Referring to FIG. 11, the automatic Internet access system using a hierarchical code according to the third embodiment of the present invention includes a code input device 1110, a user computer 1120, a routing server 1140, and a plurality of service providing servers 1150 through 1170.

The code input device 1110 deciphers code information from a code 1100 which is written on an offline medium such as a newspaper, magazine, or an advertising bill and which is related to a web page. Accordingly, the code input unit device 1110 includes a reading unit such as a digital camera or a scanner for reading the one-dimensional or two-dimensional code 1100 related to the URL of a web page to be accessed and a transmitting unit for transmitting the deciphered digital code information to the user computer 1120.

The user computer 1120 performs automatic Internet access using the code information transmitted from the code input device 1110. The user computer 1120 may be a fixed computer or a portable terminal. Regardless of a fixed computer or a portable terminal, it is supposed that the user computer 1120 used in this embodiment of the present invention allows access to the Internet through subscription for a PC communication service or securing of a private line, allows Internet search through a web browser such as Internet Explorer or Netscape, and allows execution of an application program for decoding the code information input from the code input device 1110. The user computer 1120 accesses the routing server 1140 and the plurality of service providing servers 1150 through 1170 through the Internet 1130. The user computer 1120 acquires hierarchical code information by decoding the code information received from the code input device 1110, transmits hierarchical code information to the routing server 1140, and is provided with a desired service from the service providing server 1150, 1160, or 1170.

The routing server 1140 receives the hierarchical code information from the user computer 1120 through the Internet 1130, deciphers the hierarchical code information, and transmits a detailed code contained in the hierarchical code information through the Internet 1130 to the service providing server 1150, 1160, or 1170 corresponding to a service code contained in the hierarchical code information.

Each of the service providing servers 1150, 1160, and 1170 receives a detailed code from the routing server 1140 and transmits resulting information corresponding to the detailed code to the user computer 1120. Referring to FIG. 11, the automatic Internet access system according to the third embodiment of the present invention includes service providing servers such as an address server 1150, an electronic name card server 1160, and an electronic commerce server 1170.

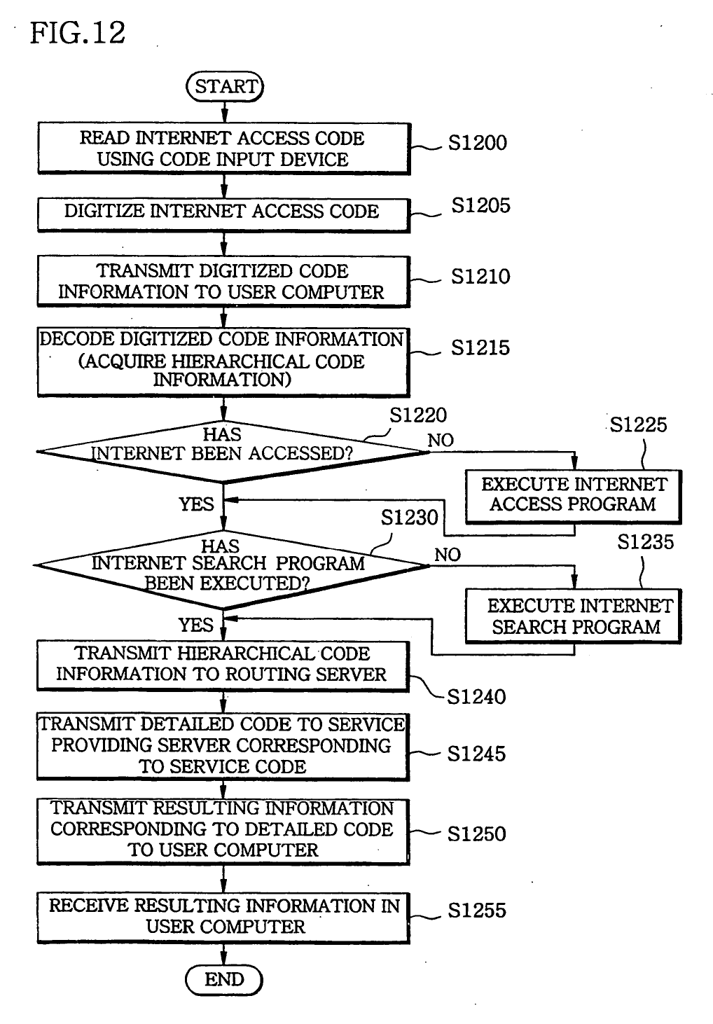

FIG. 12 is a flowchart of an automatic Internet access method of searching a particular web page on the Internet using an automatic Internet access system using a hierarchical code according to the third embodiment of the present invention.

The code input device 1110 reads the Internet access code 1100, which is marked on a newspaper or other advertising medium and indicates information related to the URL of a particular web page, in response to a user's operation in step S1200.

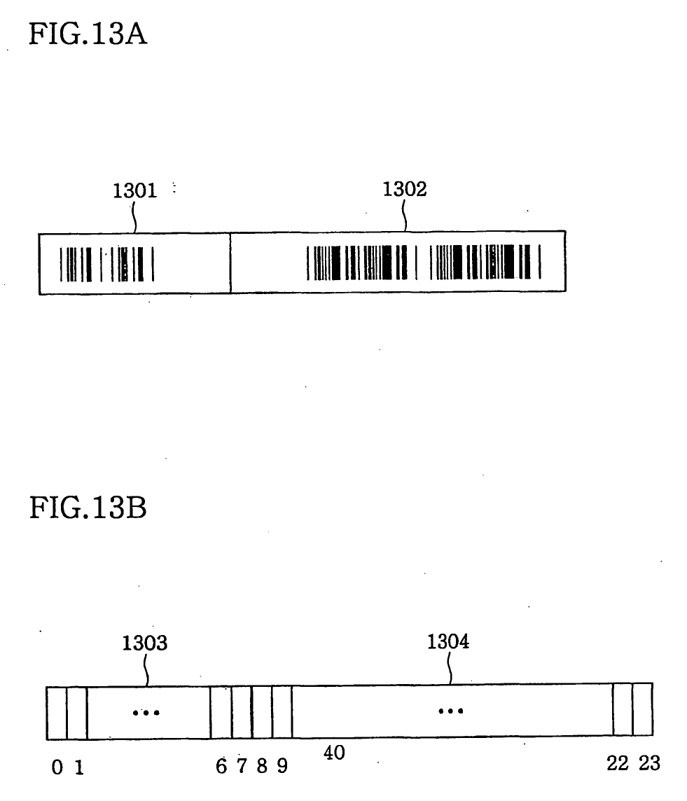

As shown in FIG. 13A, a hierarchical code according to the third embodiment of the present invention includes a server code 1301 and a detailed code 1302. The service code 1301 defines the character or meaning of information indicated by the detailed code 1302. In other words, the service code 1302 indicates the kind of service provided through an Internet access code. Accordingly, when the detailed code 1302 indicates direct URL information or indirect index information, the service code 1301 can function as an identifier for identifying that the detailed code 1302 is direct URL information or that the detailed code 1302 is indirect index information. The detailed code 1302 may be related to a service different from direct/indirect access to the Internet. For example, when an automatic Internet access system using a hierarchical code according to the present invention provides an electronic name card service and an electronic commerce service in addition to a direct access method and an indirect access method, the service code 1301 may have four values. More specifically, the service code 1301 may have a first value indicating that the detailed code 1302 indicates direct URL information, a second value indicating that the detailed code 1302 indicates indirect index information, a third value indicating that the detailed code 1302 indicates information for identifying an owner of an electronic name card, and a fourth value indicating that the detailed code 1302 indicates a unique code of a product related to electronic commerce. Four kinds of services have been described above, but the kinds of service provided by an automatic Internet access system using a hierarchical code according to the present invention are not restricted thereto. It will be apparent that any kind of service can be provided.

FIG. 13B shows an example of the structure of a hierarchical code according to the present invention. Referring to FIG. 13B, the hierarchical code has a binary value and a length of 24 bits. It is assumed that the service code 1303 of the hierarchical code is composed of 8 bits, and the detailed code 1304 is composed of the remaining 16 bits. Accordingly, when it is assumed that a first binary value of the hierarchical code is a bit 0, and that the last binary value is a bit 23, bits 0 through 7 constitute the service code 1303 and bits 8 through 23 constitute the detailed code 1304. Here, the service code 1303 has 256 different values, so 256 kinds of service can be identified by the service code 1303. As described above, the detailed code 1304 may indicate direct URL information, indirect index information, information for identifying an owner of an electronic name card, or a unique code of a product related to electronic commerce.

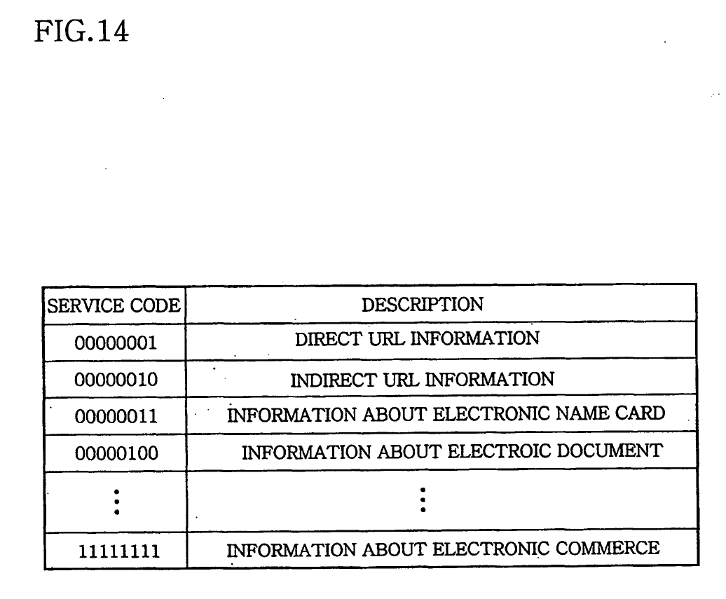

FIG. 14 is an exemplary diagram showing the kinds of service code according to the present invention.

The service code “00000001” indicates a direct access method. In this case, the detailed code contains the URL information of a web page which a user wishes to access. The service code “00000010” indicates an indirect access method. In this case, the detailed code contains index information indicating a location where the URL information of a web page which a user wishes to access is stored. The service code “00000011” indicates an electronic name card service. In this case, the detailed code may contain the serial number of an electronic name card or a user identifier of the owner of an electronic name card. The service code “00000100” indicates an electronic document service. In this case, the detailed code may contain the serial number of an electronic document which is provided through the electronic document service. Besides, the service code “11111111” indicates an electronic commerce service. In this case, the detailed code may contain the unique code of a product related to electronic commerce.

Referring again to FIGS. 11 and 12, the Internet access code 1100 is digitized by a central processing unit provided in the code input device 1110 in step S1205. Digitized code information is transmitted to the user computer 1120 in step S1210. Here, the Internet access code 1100 read by the code input device 1110 is transmitted to the user computer 1120 in the form of digitized code image information. Alternatively, the Internet access code 1100 read by the code input device 1110 can be decoded by the code input device 1110, and decoded index information can be transmitted to the user computer 1120.

The user computer 1120 decodes the digitized code image information to acquire hierarchical code information including a service code and a detailed code in step S1215.

Subsequently, it is determined whether the user computer 1120 has accessed the Internet 1130 in step S1220. If it is determined that the user computer 1120 has not accessed the Internet 1130, an internet access program previously installed in the user computer 1120 is executed for access to the Internet 1130 in step S1225. These steps can be performed manually but can be automatically performed by a predetermined program installed in the user computer 1120. If it is determined that the user computer 1120 has accessed the Internet 1130 in step S1220, or after completing access to the Internet 1130 through step S1225, it is determined whether an Internet search program has been executed in the user computer 1120 in step S1230. If it is determined that an Internet search program has not been executed, an Internet search program set in the user computer 1120 is executed in step S1235. For the Internet access program and the Internet search program, existing programs can be used in this embodiment of the present invention. However, it will be apparent that predetermined programs created according to the present invention can be used.

Thereafter, the user computer 1120 transmits the hierarchical code information to the routing server 1140 through the Internet 1130 using the Internet search program in step S1240.

The routing server 1140 transmits the detailed code to the service providing server 1150, 1160, or 1170 providing a service determined by the service code contained in the hierarchical code information in step S1245.

The service providing server 1150, 1160, or 1170 which has received the detailed code from the routing server 1140 performs a service according to the information of the detailed code and transmits the resulting information to the user computer 1120 in steps S1250 and S1255.

Hereinafter, operations depending on the kinds of service indicated by a service code contained in the Internet access code 1100 will be described using examples.

First the case where a service code indicates an indirect access method will be described. If the code input device 1110 reads the Internet access code 1100 according to a user's operation, the user computer 1120 transmits the result of reading (hierarchical code information) containing the service code and a detailed code to the routing server 1140. Here, an identifier, such as an IP address of the user computer, for identifying the user computer 1120 can be transmitted to the routing server 1140 together with the result of reading. The routing server 1140 checks the service code of the received hierarchical code information. If it is determined that the service code indicates an indirect access method, the routing server 1140 transmits the detailed code to the address server 1150. Here, the routing server 1140 can transmits an identifier such as an IP address of the user computer 1120 and the service code, when necessary, to the address server 1150 together with the detailed code. The address server 1150 stores a plurality of indexes and URL information of web pages corresponding to the indexes. Accordingly, when the address server 1150 receives the detailed code indicating index information, the address server 1150 derives URL information corresponding to the index information and transmits the URL information to the user computer 1120. Thereafter, the user computer 1120 accesses a desired web page using the URL information transmitted from the address server 1150 and display the content of the web page using a web browser.

Next, the case where a service code indicates an electronic name card service will be described. If the code input device 1110 reads the Internet access code 1100 according to a user's operation, the user computer 1120 transmits the result of reading (hierarchical code information) containing the service code and a detailed code to the routing server 1140. Here, an identifier, such as an IP address of the user computer, for identifying the user computer 1120 can be transmitted to the routing server 1140 together with the result of reading. The routing server 1140 checks the service code of the received hierarchical code information. If it is determined that the service code indicates an electronic name card service, the routing server 1140 transmits the detailed code to the electronic name card server 1160. Here, the routing server 1140 can transmits an identifier such as an IP address of the user computer 1120 and the service code, when necessary, to the electronic name card server 1160 together with the detailed code. The electronic name card server 1160 stores the unique identifiers of subscribers to the electronic name card service and subscriber information such as telephone numbers, addresses, and electronic mail addresses. If the electronic name card server 1160 receives the detailed code indicating the identifier of a subscriber, it derives subscriber information corresponding to the identifier from a database (not shown), generates a web page in the form of an electronic name card, and transmits the generated web page to the user computer 1120.

Next, the case where a service code indicates an electronic commerce service will be described. If the code input device 1110 reads the Internet access code 1100 recorded on a printed medium such as a catalog of products according to a user's operation, the user computer 1120 transmits the result of reading (hierarchical code information), which contains the service code and a detailed code, to the routing server 1140. Here, an identifier, such as an IP address of the user computer, for identifying the user computer 1120 can be transmitted to the routing server 1140 together with the result of reading. The routing server 1140 checks the service code of the received hierarchical code information. If it is determined that the service code indicates an electronic commerce service, the routing server 1140 transmits the detailed code to the electronic commerce server 1170. Here, the routing server 1140 can transmits an identifier such as an IP address of the user computer 1120 and the service code, when necessary, to the electronic commerce server 1170 together with the detailed code. The electronic commerce server 1170 stores the unique codes of products provided by electronic commerce companies and additional product information such as product image information and product function description information. If the electronic commerce server 1170 receives the detailed code indicating the unique code of a product, it derives additional product information corresponding to the unique code from a database (not shown), arranges the additional produce information in the form of a web page, and transmits the generated web page to the user computer 1120. Here, a section for confirming purchasing can be added to the web page transmitted to the user computer 1120 in another embodiment.

Meanwhile, in the case of an electronic commerce service, if user information can be previously obtained, not only can a user be conveniently provided with the service, but also an electronic commerce company can efficiently provide the service. Accordingly, in another embodiment, the user computer 1120 can receive user information from a user in advance and can automatically transmit the user information to the electronic commerce server 1170 in order to avoid an additional step of inputting the user information.

In addition, in yet another embodiment, different service code values can be set for different electronic commerce companies. In other words, although a service code for an electronic commerce service is set to “11111111” in the description of FIG. 14, in the case where a plurality of electronic commerce companies use an automatic Internet access method using a hierarchical code according to the present invention, it is possible that difference service code values can be assigned to the respective electronic commerce companies.

Besides, in the case where a service code indicates a direct access method, the user computer 1120 can directly access a desired web page using URL information which can be obtained from a detailed code. However, in another embodiment, although a service code indicates a direct access method, hierarchical code information can be transmitted to the routing server 1140 and a corresponding web page can be accessed through the routing server 1140, for an object such as statistical processing.

Meanwhile, a color code can be used for an Internet access code used in the embodiments of an automatic Internet access system according to the present invention.

In other words, in a usual Internet access code, a code portion is black and its background is white because a code input device for recognizing the image of the Internet access code usually recognizes only black and white images. However, if a code input device can recognize color images, a color Internet access code can be more efficient in terms of the amount of information which can be expressed in a unit area of the Internet access code.

All of the colors which can be presented by light can be made by combination of red (R), green (G), and blue (B). Generally, an information processing system combines R, G, and B to present a single color. For example, in the case of representing each of R, G, and B using 8 bits, white can be represented by R=FF, G=FF, and B=FF in a hexadecimal version, and black can be represented by R=00, G=00, and B=00 in a hexadecimal version. Accordingly, if each code can be composed of R (FF0000), G (00FF00), B (0000FF), and black (000000), one type of code can have four different values. In this case, the amount of information which can be expressed in a unit area increases by four times compared to black and white. In the case of representing the color of a code using an 8-bit RGB combination, the amount of information, which can be expressed in the same type of code, theoretically increases by 256*256*256=16,777,216 times.

It will be apparent to those skilled in the art that another embodiment can be made by combining the elements of such an automatic Internet access system and method using a double code as described above and the elements of such an automatic Internet access system and method using a hierarchical code as described above.

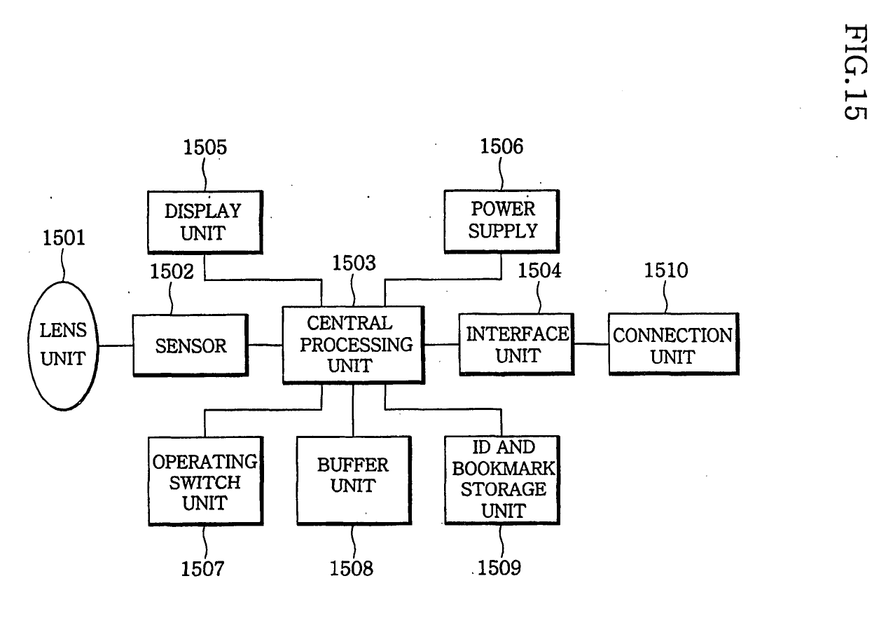

FIG. 15 is an exemplary diagram of the configuration of each of the code input devices 110, 710, and 1110 used in the present invention. Referring to FIG. 15, each of the code input devices 110, 710, and 1110 includes a lens unit 1501, a sensor 1502, a central processing unit 1503, an interface unit 1504, a display unit 1505, a power supply 1506, an operating switch unit 1507, a buffer unit 1508, an ID and bookmark storage unit 1509, and a connection unit 1510.

According to a user's operation of the operating switch unit 1507, the Internet access code 100, 700, or 1100 on a printed medium is captured by the sensor 1502 through the lens unit 1501. Captured code information is converted into digital information by the central processing unit 1503. The digital information is transmitted to the user computer 120, 720, or 1120 through the interface unit 1504 and the connection unit 1510.

The lens unit 1501 can be realized as a glass lens or a plastic lens. The sensor 1502 can be realized as a complementary metal-oxide semiconductor (CMOS) image sensor or a charge-coupled device (CCD) image sensor. For the central processing unit 1503, a universal microprocessor or a specially designed semiconductor chip can be used. In addition, the central processing unit 1503 may be provided with a memory unit which stores a predetermined program according to the present invention.

The code input device 110, 710, or 1100 can be connected to the user computer 120, 720, or 1120 by wire or wirelessly. Here, in the case of wire connection, a universal serial bus (USB) port, a serial port, a parallel port, or IEEE1394 can be used. In the case of wireless connection radio frequency (RF), Bluetooth, or infrared rays (IrDA) can be used. If the Internet access code 100, 700, or 1100 is captured under a state in which the code input device 110, 710, or 1110 is connected to the user computer 120, 720, or 1120, digitized code image information is transmitted to the user computer 120, 720, or 1120 through the interface 1504 and the connection unit 1510, and an Internet access procedure is automatically performed according to the present invention. The code image information which has been digitized by the central processing unit 1503 of the code input device 110, 710, or 1110 is decoded according to an application program installed in the central processing unit 1503 and transmitted to the user computer 120, 720, or 1120. Alternatively, the digitized code image information can be decoded according to an application program installed in the user computer 120, 720, or 1120 after being transmitted to the user computer 120, 720, or 1120.

The code input device 110, 710, or 1110 can be portably used without being connected to the user computer 120, 720, or 1120. Here, if the Internet access code 100, 700, or 1100 is captured by the code input device 110, 710, or 1110, code image information digitized by the central processing unit 1503 is stored in the buffer unit 1508. The amount of digitized code image information which can be stored in the buffer unit 1508 depends on the capacity of the buffer unit 1508. For the buffer unit 1508, a typical memory unit can be used. In another embodiment, the digitized code image information can be stored in the buffer unit 1508 in a decoded form such as index information, a double code, or a hierarchical code using the central processing unit 1503. If a portable code input device is connected to the user computer 120, 720, or 1120, the digitized code image information or the decoded information, which is stored in the buffer unit 1508, is transmitted to the user computer 120, 720, or 1120 through the interface unit 1504 and the connection unit 1510, and an automatic Internet access procedure is performed.

The ID and bookmark storage unit 1509 can store device information such as the serial number of the code input device 110, 710, or 1110 or information (referred to as an ID) indicating a provider providing the code input device 110, 710, or 1110 to an Internet user. In addition, the ID and bookmark storage unit 1509 can store digitized image information of a code that is frequently captured by the Internet user. If digitized code image information indicating an Internet site frequently retrieved by the Internet user has been stored in the ID and bookmark storage unit 1509, the digitized code image information stored in the ID and bookmark storage unit 1509 is transmitted to the user computer 120, 720, or 1120 through the interface unit 1504 and the connection unit 1510 whenever the Internet user presses a relevant switch in the operating switch unit 1507, and an automatic Internet access procedure is performed. In FIG. 15, the ID and bookmark storage unit 1509 is separately formed from the buffer unit 1508, but it is apparent that the ID and bookmark storage unit 1509 and the buffer unit 1508 can be integrated into one module.

In addition, in another embodiment, the ID information of the code input device 110, 710, or 1110 can be transmitted, when the user computer 120, 720, or 1120 implements automatic access through the Internet 130, 730, or 1130.

The above-described code input device 110, 710, or 1110 is only an example, and it will be apparent that an input device or scanner which can read a bar code can be used. For example, the code input device 110, 710, or 1110 of the present invention can be configured using a scanner module, which is used in, for example, a portable scanner type electronic dictionary.

While this invention has been particularly shown and described with reference to preferred embodiments thereof, it will be understood by those skilled in the art that various changes may be made within the scope which does not beyond the essential characteristics of this invention. Therefore, the above embodiments have been used in a descriptive sense only and not for purpose of limitation. It will be understood that the scope of the invention will be defined not by the above description but by the appended claims, and all differences within the scope defined by the claims are covered by the present invention.

### INDUSTRIAL APPLICABILITY

According to the present invention, even a web page having a long uniform resource locator (URL) can be easily accessed by recording an index of the URL in an Internet access code instead of directly recording the URL, and information about web page access can be managed integrally.

In addition, loads on an address server, which accompany automatic Internet access, are equalized by forming an Internet access code as a double code including a server code and an index code and supporting a plurality of address servers.

Moreover, an Internet access code is formed as a hierarchical code including a service code and a detailed code, thereby efficiently providing various services.

What is claimed is:

1. An automatic Internet access method of accessing a particular web page on Internet using an indirect code, the automatic Internet access method comprising the steps of:
(a) deciphering code information from a code which is recorded in an offline medium and is related to the web page;
(b) decoding the deciphered code information to acquire index information related to the web page;
(c) acquiring address information corresponding to the acquired index information on a network; and
(d) accessing the web page using the acquired address information and receiving information related to the web page.

2. The automatic Internet access method of claim 1, wherein the code related to the web page is one of a one-dimensional code and a two-dimensional code, in which the index information related to the web page is coded by a predetermined method.

3. The automatic Internet access method of claim 1 or 2, wherein the address information contains a uniform resource locator (URL) of the web page.

4. An automatic Internet access system for accessing a particular web page on Internet using an indirect code, the automatic Internet access system comprising:
a code input device for deciphering code information from a code which is recorded in an offline medium and is related to the web page;
an address server for receiving index information and providing address information corresponding to the index information on a network; and
a user computer for decoding the code information deciphered by the code input device to acquire the index information related to the web page, acquiring the address information corresponding to the index information using the address server, accessing the web page using the address information, and receiving information related to the web page.

5. The automatic Internet access system of claim 4, wherein the code related to the web page is one of a one-dimensional code and a two-dimensional code, in which the index information related to the web page is coded by a predetermined method.

6. The automatic Internet access system of claim 4 or 5, wherein the address information contains a uniform resource locator (URL) of the web page.

7. An automatic Internet access system for accessing a particular web page on Internet using an indirect code, the automatic Internet access system comprising:
a code input device for deciphering code information from a code which is recorded in an offline medium and is related to the web page and decoding the deciphered code information to acquire index information related to the web page;
an address server for receiving index information and providing address information corresponding to the index information on a network; and
a user computer for acquiring the address information, which corresponds to the index information acquired by the code input device, using the address server, accessing the web page using the address information, and receiving information related to the web page.

8. The automatic Internet access system of claim 7, wherein the code related to the web page is one of a one-dimensional code and a two-dimensional code, in which the index information related to the web page is coded by a predetermined method.

9. The automatic Internet access system of claim 7 or 8, wherein the address information contains a uniform resource locator (URL) of the web page.

10. An automatic Internet access method of accessing a particular web page on Internet using a double code, the automatic Internet access method comprising the steps of:
(a) deciphering code information from a code which is recorded in an offline medium and is related to the web page;
(b) decoding the deciphered code information to acquire double code information related to the web page;
(c) transmitting an index code contained in the double code information to an address server corresponding to a server code contained in the double code information;
(d) receiving address information corresponding to the index code from the address server; and
(e) accessing the web page using the address information and receiving information related to the web page.

11. An automatic Internet access system for accessing a particular web page on Internet using a double code, the automatic Internet access system comprising:
a user computer for deciphering code information from a code which is recorded in an offline medium and is related to the web page, decoding the deciphered code information to acquire double code information related to the web page, and transmitting an index code contained in the double code information to an address server corresponding to a server code contained in the double code information; and
a plurality of address server for receiving the index code, acquiring address information corresponding to the index code, and transmitting the address information to the user computer,
wherein the user computer accesses the web page using the address information and receives information related to the web page.

12. An automatic Internet access method of accessing a particular web page on Internet using a hierarchical code, the automatic Internet access method comprising the steps of:
(a) deciphering code information from a code, which is recorded in an offline medium and is related to the web page, using a user computer;
(b) decoding the deciphered code information to acquire hierarchical code information related to the web page using the user computer;
(c) transmitting the hierarchical code information from the user computer to a routing server;
(d) transmitting a detailed code contained in the hierarchical code information from the routing server to a service providing server corresponding to a service code contained in the hierarchical code information among a plurality of service providing servers; and
(e) transmitting resulting information corresponding to the detailed code from the service providing server to the user computer.

13. The automatic Internet access method of claim 12, wherein the service code indicates an indirect access method, the detailed code comprises index information for accessing uniform resource locator (URL) information of the web page, and the service providing server acquires the URL information of the web page, which corresponds to the index information, and transmits the URL information to the user computer in the step (e).

14. The automatic Internet access method of claim 12, wherein the service code indicates an electronic name card access method, the detailed code comprises identification information of a particular electronic name card, and the service providing server acquires electronic name card information corresponding to the identification information of the electronic name card and transmits the electronic name card information to the user computer in the step (e).

15. The automatic Internet access method of claim 12, wherein the service code indicates an electronic commerce access method, the detailed code comprises the unique code of a particular product, and the service providing server acquires product information corresponding to the unique code of the product and transmits the product information to the user computer in the step (e).

16. The automatic Internet access method of any one of claims 12 through 15, wherein the step (c) further comprises transmitting address information of the user computer on a network from the user computer to the routing server.

17. An automatic Internet access system for accessing a particular web page on Internet using a hierarchical code, the automatic Internet access system comprising:
a user computer for deciphering code information from a code which is recorded in an offline medium and is related to the web page, decoding the deciphered code information to acquire hierarchical code information related to the web page, and transmitting the hierarchical code information to a routing server;
a routing server for transmitting a detailed code contained in the hierarchical code information to a service providing server corresponding to a service code contained in the hierarchical code information among a plurality of service providing servers; and
a plurality of service providing servers for transmitting resulting information corresponding to the detailed code to the user computer.

18. The automatic Internet access system of claim 17, wherein when the service code indicates a direct access method as a result of deciphering the service code, the user computer accesses the web page using uniform resource locator (URL) information of the web page, which is contained in the detailed code, and receives information related to the web page.

19. The automatic Internet access system of claim 17, wherein one among the plurality of service providing servers is an address server for acquiring uniform resource locator (URL) information of the web page, which corresponds to index information contained in the detailed code of the hierarchical code information, and transmitting the URL information to the user computer.

20. The automatic Internet access system of claim 17, wherein one among the plurality of service providing servers is an electronic name card server for acquiring electronic name card information corresponding to identification information of a particular electronic name card, the identification information being contained in the detailed code of the hierarchical code information, and transmitting the electronic name card information to the user computer.

21. The automatic Internet access system of claim 17, wherein one among the plurality of service providing servers is an electronic commerce server for acquiring product information corresponding to a unique code of a product, the unique code being contained in the detailed code of the hierarchical code information, and transmitting the product information to the user computer.

22. The automatic Internet access system of any one of claims 17 through 21, wherein the user computer transmits its network address information to the routing server.
